(19) United States
(12) Patent Application Publication
(10) Pub. No.: US 2016/0368112 A1
(43) Pub. Date: Dec. 22, 2016

(54) Method for Grinding a Surface of a Rolling Element for a Roller Bearing

(71) Applicant: NTN-SNR ROULEMENTS, Annecy (FR)

(72) Inventors: Pascal Bartholomeau, Epagny (FR); Eric Monnet, Seynod (FR); Pierre Souillet-Desert, Saint-Jorioz (FR); Cynthia Tsen, Mouxy (FR)

(21) Appl. No.: 15/183,525

(22) Filed: Jun. 15, 2016

(30) Foreign Application Priority Data
Jun. 17, 2015 (FR) 1555558

(51) Int. Cl. B24B 5/37; B24D 7/18; F16C 33/36

(52) U.S. Cl. CPC B24B 5/37; F16C 33/366; B24D 7/18; F16C 2220/70; F16C 2240/54; B24D 3/28

(57) ABSTRACT

A method for grinding a surface of a rolling element for a roller bearing, the method including scrolling the surface along a trajectory extending successively over at least one draft band and over at least one finishing band of a grinding wheel, each one of the bands being formed from a binder wherein an abrasive is dispersed, the method providing that the binder of the finishing band be of an epoxy resin base, the binder of the draft band being of an organic resin base of a different chemical nature and comprising an abrasive of which the size of the grains is greater than that of the abrasive of the finishing band.

### CROSS-REFERENCE TO RELATE APPLICATION

The present application claims priority to French Patent Application No. FR-15 55558, filed Jun. 17, 2015. The priority application, FR-15 55558, is hereby incorporated by reference.

### FIELD OF THE INVENTION

The invention relates to a method for grinding a surface of a rolling element for a roller bearing as well as such a rolling element having at least one ground surface by implementation of this method.

In particular, the invention is applied for the grinding of a surface of a tapered roller, in particular of the large face that has a spherical geometry, said roller being for example intended to guide the rotation of a bearing of a gearbox of a motor vehicle.

To do this, the use of a wheel of the right cup type is known of which the grinding surface has a radius corresponding to that of the face of the roller for grinding, said face being displaced along a trajectory of said surface which is arranged to confer upon said face the sphericity and the surface condition, characterised in particular by the roughness Ra (arithmetic average roughness), expected.

In particular, the grinding trajectory can extend over at least one band having a binder, in particular in the form of a resin, wherein an abrasive is dispersed, said abrasive being chosen specifically according to the quality of the grinding expected.

According to a particular embodiment, the grinding trajectory extends successively over a draft band and over a finishing band, with the abrasive dispersed in the resin being arranged, in particular by a differential size of abrasive grains between the bands, in order to successively perform a draft grinding operation with substantial removal of material and a finishing grinding operation making it possible to improve the surface condition of said draft, in particular by reducing its roughness.

However, in order to reduce the drag torque induced by the friction during the rotation of the rolling elements in the bearing, an optimal grinding quality is sought, in particular relatively to a roughness Ra that is as low as possible.

The invention aims to improve prior art by proposing in particular a method for grinding a surface of a rolling element using a wheel of which the draft and finishing bands are optimised, in particular to control the geometry of said surface and reducing its roughness.

To this effect, according to a first aspect, the invention proposes a method for grinding a surface of a rolling element for a roller bearing, said method providing to scroll said surface along a trajectory extending successively over at least one draft band and over at least one finishing band of a grinding wheel, with each one of said bands being formed from a binder wherein an abrasive is dispersed, said method providing that the binder of the finishing band be of an epoxy resin base, with the binder of the draft band being of an organic resin base of a different chemical nature and comprising an abrasive of which the size of the grains is greater than that of the abrasive of said finishing band.

### BRIEF DESCRIPTION OF THE DRAWINGS

According to a second aspect the invention proposes a rolling element for a roller bearing having at least one ground surface through the implementation of such a method, said surface having a roughness Ra which is less than or equal to 0.10 μm.

Other objects and advantages of the invention shall appear in the following description, made in reference to the attached figures, wherein:

FIG. 1 is a representation of a tapered roller on the large face of which a method for grinding according to the invention is implemented;

FIG. 2a is a perspective view of a wheel for the implementing of a method for grinding a surface of a rolling element according to the invention;

FIG. 2b is a longitudinal cross-section view of a wheel for the implementing of a method for grinding a surface of a rolling element according to the invention;

FIG. 3 is a front view of the grinding surface of the wheel of FIG. 2 whereon the grinding trajectory is shown.

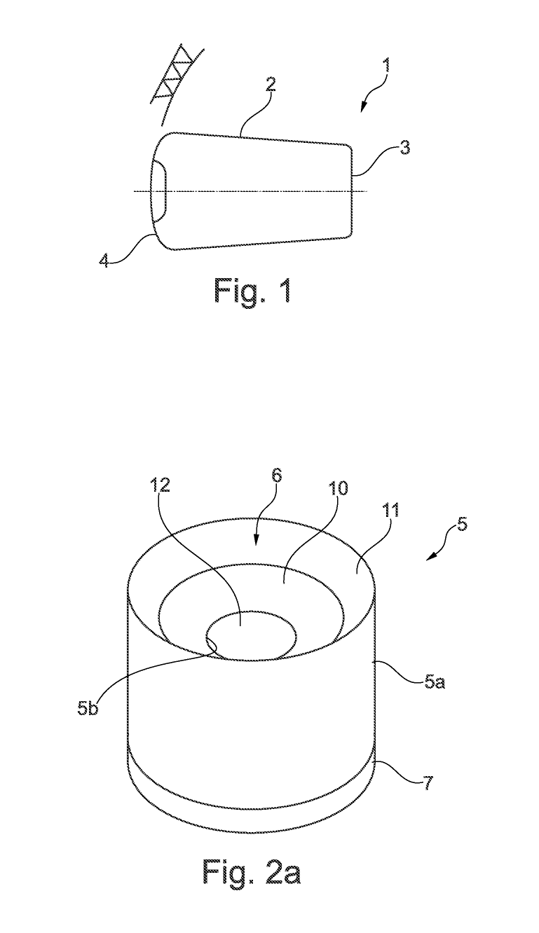

### DETAILED DESCRIPTION OF THE PREFERRED EMBODIMENTS

In relation with figures, a rolling element 1 for a roller bearing is described hereinbelow, in particular in the form of a tapered roller having a tapered periphery 2 bordered on either side by a small base 3 and by a large spherical face 4.

The rolling elements 1 are intended to be arranged in a bearing space formed between an inner member and an outer member of a bearing in order to be able to guide their relative rotation. Tapered roller bearings, through their ability to withstand substantial radial and axial forces, particularly have their application for the guiding in rotation of mechanical members for torque transmission, in particular gearboxes of motor vehicles.

The rolling elements 1 are conventionally made from bearing steel, for example of the 100Cr6 type, in order to withstand the bearing contact pressures. In order to guarantee optimum guiding of the rotation of the bearing, the periphery 2 and at least the large face 4 of the rolling elements 1 must be ground. In particular, the grinding makes it possible to define the outer geometry of the rolling element 1 and to improve its surface condition, characterised in particular by its roughness Ra, so as in particular to limit the drag torque induced by the friction during the rotation of said rolling elements in the bearing.

To do this, after a first operation of forming, by deformation or machining, and heat treatment, the rolling element 1 is subjected to a method for grinding at least one surface among in particular its periphery 2 and its large face 4. In relation with the figures, the implementation of a method for the grinding of the large spherical face 4 of a tapered roller 1 is described hereinbelow.

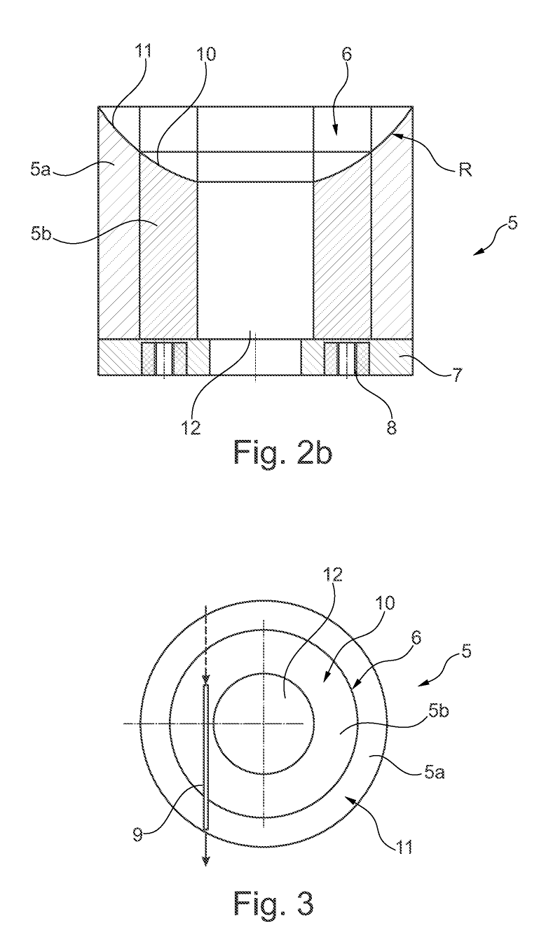

In relation with FIGS. 2, the method uses a wheel 5 of the right cup type of which the grinding surface 6 has a radius R which is arranged to grind the large spherical face 4 of the tapered bearings 1. Alternatively, a flat wheel can be used, said wheel being sized over its outer diameter to the radius R that is sought to grind on the face of the bearing 1.

In particular, the wheel 5 can comprise a sole 7 incorporating fastenings 8 on a machine which is arranged in particular to arrange said wheel in rotation in front of a tool turret driving in particular the tapered bearings 1 in rotation, the relative displacement of the wheel 5 and of the tapered bearings 1 being arranged to carry out the expected grinding. Alternatively, the finishing band 5a can integrate the fastenings of the wheel 5.

In particular, the grinding can be carried out by:

placing several rolling elements 1 in respectively a cell of a retaining cage mounted on the tool turret;

placing in rotation the rolling elements 1 on themselves;

scrolling each one of the faces 4 along a trajectory 9 of the grinding surface 6 of the wheel 5, set into rotation about itself, in order to reproduce the spherical shape on said faces.

The wheel 5 has a draft band 10 and a finishing band 11 whereon the grinding trajectory 9 extends successively. As such, a grinding draft can be realised by removing material then a finishing by reducing the roughness in order to improve the surface condition of said draft. In particular, the finishing band 11 can surround the draft band 10 in order to form a grinding surface 9 that extends outwards from the grinding surface 6.

In an alternative not shown, the wheel 5 can have an additional band on which the grinding trajectory 9 extends, in particular a band devoid of abrasive, for example with an epoxy resin base, said band able to be provided on the surface of the wheel 5 so that the trajectory 9 finishes on said band in order to prevent the bearings 1 from being damaged when they exit from the grinding surface 6. Furthermore, according to the direction of the grinding trajectory 9, a wheel can be considered on which the draft band 10 surrounds the finishing band 11.

In relation with FIGS. 2, the wheel 5 comprises an outer annular body 5a surrounding an inner annular body 5b, said corps extending concentrically from the sole 7 to a joint free surface by being integral together. Moreover, the inside body 5b as well as the sole 7 form a bore 12 that axially passes through the wheel 5, said wheel able to have a diameter between 135 and 350 mm for a height between 150 and 175 mm.

The free surface is sized, in particular in order to provide it with the radius R desired for the large face 4 to be ground, in order to form the grinding surface 6, the draft band 10—respectively finishing band 11—being formed on the free surface of the inside body 5b—respectively outside body 5a.

Each one of the bands 10, 11 is formed from a binder wherein an abrasive is dispersed, the binder of the finishing band 11 being of an epoxy resin base, the binder of the draft band 10 being of an organic resin base of a different chemical nature and comprising an abrasive of which the size of the grains is greater than that of the abrasive of said finishing band.

As such, the draft 10 and finishing 11 bands are optimised, in particular in order to be able to control the sphericity of the face 4 with good tolerance while still improving its surface condition, in particular by reducing its roughness Ra to a level less than or equal to 0.10 μm. In particular, the organic resin binder allows for a removal of material between 50 and 300 μm without excessive heating and the epoxy resin binder makes it possible to achieve the expected roughness Ra.

This optimisation is particularly advantageous for substantial wheel diameters, for which the use of a conventional wheel leads to an imperfect surface condition.

Furthermore, a roughness Ra less than 0.10 μm is particularly desirable on the large face 4 of a tapered roller 1 in that it is conventionally supported on a collar of a member to maintain the cohesion of the bearing, said support inducing a drag torque that is particularly important to reduce.

According to an embodiment, the organic resin of the draft band 10 can be obtained via polymerisation, for example from a mixture of formol and of phenol, said polymerisation being carried out hot (typically around 180° C.). As such, a resin is obtained that, in relation with a substantial abrasive grain size, is favourable for the removal of material by limiting heating.

Moreover, the epoxy resin of the finishing band 11 can be obtained by cross-linking at ambient temperature of an epoxy polymer. In particular, the epoxy resin may not require curing, the mould for forming the wheel 5 able to be preheated, to allow for the chemical cross-linking reaction. As such, a resin is obtained that, in relation with a small abrasive grain size, is favourable for reducing roughness.

Advantageously, the grinding can be implemented with a wheel 5 of which the width, i.e. the dimension according to the radius, of each band 10, 11 is between 25% and 75% of the width of the grinding surface 6. In the embodiment shown, the draft band 10 has a width that is greater than that of the finishing band 11.

Moreover, in relation with FIG. 3, the grinding trajectory 9 extends parallel to the diameter of the wheel 5 by being offset from said diameter by a radial distance. In particular, this realisation makes it possible to maintain the surface to be ground on a draft trajectory that is longer than the finishing trajectory, for example by being between two and four times longer.

According to an embodiment, the abrasive dispersed in each one of the binders has an aluminium oxide base (Al₂O₃) in particular in the form of alumina or corundum (α-Al₂O₃) that can have undergone a chemical treatment allowing it to confer particular properties, for example brittleness, silicon carbide (SiC) and/or cubic boron nitride (CBN), the size of the grains of the abrasive according to the FEPA standard (number of abrasive grains per inch) able to be chosen in the range 120-240 for the draft band 10 and in the range 240-600 pour the finishing band 11. According to an embodiment, a mixture of grain sizes can be dispersed in the binder of the draft band 10 and/or finishing band 11.

1. A method for grinding a surface of a rolling element for a roller bearing, said method including scrolling said surface along a trajectory extending successively over at least one draft band and over at least one finishing band of a grinding wheel, each one of said bands being formed from a binder wherein an abrasive is dispersed, and in scrolling the surface along the trajectory extending successively over at least one draft band and over at least one finishing band of a grinding wheel, that the binder of the finishing band being of an epoxy resin base, the binder of the draft band being of an organic resin base of a different chemical nature and comprising an abrasive of which the size of the grains is greater than that of the abrasive of said finishing band.

2. The method for grinding according to claim 1, and in scrolling the surface along the trajectory extending successively over at least one draft band and over the least one finishing band of a grinding wheel, the grinding wheel is a wheel of the right cup type of which the grinding surface has a radius (R) which is arranged to grind a spherical surface of the rolling element.

3. The method for grinding according to claim 1, characterized in that it uses a wheel of which the finishing band surrounds the draft band.

4. The method for grinding according to claim 1, characterized in that it uses a wheel of which the draft band surrounds the finishing band.

5. The method for grinding according to claim 1, characterized in that it uses a wheel having a band devoid of abrasive.

6. The method for grinding according to claim 1, characterized in that it uses a wheel of which the width of each band is between 25% and 75% of the width of the grinding surface.

7. The method for grinding according to claim 1, characterized in that the abrasive dispersed in each one of the binders has an aluminum oxide, silicon carbide or cubic boron nitride base.

8. The method for grinding according to claim 1, characterized in that the size of the grains of the abrasive according to the standard FEPA is chosen in the range 120-240 for the draft band and in the range 240-600 for the finishing band.

9. The method for grinding according to claim 1, characterized in that it uses a wheel of which the organic resin of the draft band is obtained by polymerization carried out hot.

10. The method for grinding according to claim 1, characterized in that it uses a wheel of which the epoxy resin of the finishing band is obtained by cross-linking at ambient temperature.

11. The method for grinding according to claim 1, characterized in that it is implemented for the grinding of a large spherical face of a tapered roller.

12. The method for grinding according to claim 1, characterized in that the wheel and/or the rolling element are placed into rotation on themselves during the grinding.

13. The rolling element for a roller bearing having at least one ground surface through implementation of a method according to claim 1, said surface having a roughness Ra which is less than or equal to 0.10 μm.
